(19) United States
(12) Patent Application Publication
(10) Pub. No.: US 2014/0371045 A1
(43) Pub. Date: Dec. 18, 2014

(54) Device and Method for Preparing Packaging Boxes With Vertical Unstacking

(71) Applicant: Otor, Puteaux (FR)

(72) Inventors: Thomas Bruneau, Chenove (FR); Franck Menegazzi, Dijon (FR)

(73) Assignee: Otor, Puteaux (FR)

(21) Appl. No.: 14/374,037

(22) PCT Filed: Feb. 1, 2013
(86) PCT No.: PCT/FR2013/050226

§ 371 Date: Jul. 23, 2014

(30) Foreign Application Priority Data
Feb. 3, 2012 (FR) FR12/00339

(51) Int. Cl. B31B 1/74

(52) U.S. Cl. CPC B31B 1/74
USPC 493/52

(57) ABSTRACT

The invention relates to a device (1) and a method for preparing a packaging box (2, 74) from at least one storage location (3) for a stack (4, 68, 69) of corrugated cardboard cut-outs, including means (6) for moving the stack forward while same is being unstacked and means (7) for unstacking the cut-outs by means of suction. Since the cut-outs are stacked vertically, the means (6) for moving the stack forward comprise a plate (8) for lifting the stack vertically up to an engagement plane (9) for the cut-out (28) located on top. The device comprises means (27) for locating the X, Y, Z position (pᵢ) of the top cut-out in the storage location and means (29) for calculating the X, Y, Z path, comprising a vertical component, and means for unstacking on the basis of said position (pᵢ), which are designed to control the movement of said unstacking means between a position (9) for grasping the cut-out and a position for positioning same a predetermined work station likewise located at X, Y, Z.

The present invention relates to a device for forming a packaging box from at least one magazine for storing a stack of corrugated board cutouts, comprising means for advancing the stack as it is unstacked and means for unstacking the cutouts by suction.

It also relates to a method for forming a packaging box from such a device.

Numerous devices and methods for forming corrugated board boxes are already known.

Such methods generally comprise the following steps:

After a hoard blank is taken by a sucker from an inclined magazine, adhesive is applied to the blank or cutout then it is three-dimensionally shaped before the flaps forming the bottom and the walls of the box thus formed are closed by folding.

Such methods require regular filling of the magazine.

In order to do this, the most widespread way of loading the magazine uses manual intervention of operators from pallets on which the cutouts are stacked.

However, this repetitive manual loading proves to be very demanding in the long term, above all because the loading frequency of the magazines is high, the weight and/or dimensions of the cutouts are large, and it is possibly necessary to use a plurality of magazines in parallel in order to form boxes from two or more blanks or cutouts.

By way of example, a machine operating at a rate of thirty boxes per minute in order to form 300 gram packages requires the handling of about four tons of cardboard per day (over eight hours).

Such handling raises health problems for the operators, who therefore experience musculoskeletal disorders.

Solutions have therefore been sought making it possible to load the magazines automatically, without an operator having to lift batches of board.

Gripping systems are also known, capable of lifting and moving simultaneously a plurality of board panels in packets, which makes it possible to transfer an entire stack of board from a palette to the magazine.

One difficulty in using such systems consists in gripping the stack.

Gripping of a stack which is carried out by lateral jaws is in fact difficult, to carry out exactly and repetitively.

For example, needles inserted between two board panels via one side of the stack to be moved are used, slightly lifting the stack slantwise on the side and making it possible to introduce one or more thin plates or blades under the stack to be lifted.

With such a system, however, the gripping of an exact number of boards is not ensured.

The known solutions furthermore have the following drawbacks.

Firstly, they limit the possibilities of gripping the cutouts.

This is because it is necessary for two opposite edges of the cutouts to he accessible in order that they can be taken with the jaws.

They are also not suitable if the shapes of the cutouts allow them to be interleaved on the pallets, preventing them from being gripped rapidly and reliably.

Another drawback is the impossibility of reaching cutouts located at the very bottom of the palette, these being impossible to extract automatically. They are therefore often lost, which entails significant wastage, or they have to be taken up manually, with the drawbacks mentioned above.

Lastly, if the pallets are shaken during the handling which precedes their positioning in the unstacking zone, the cutouts of a given palette will be displaced and will often be interleaved with one another, which prevents them from being gripped correctly.

As regards the latter drawback, although a method is known which consists in precisely measuring the position of the cutouts on the top of the stack by optical means, in order to facilitate their gripping.

It then requires specific illumination and sophisticated sensors, which are often considered to be too expensive or too complex.

The present invention aims to overcome these drawbacks by providing a device and is method which meet practical requirements better than those previously known, particularly because they make it possible to form a packaging box at a high rate and without interruption, while providing a system for supplying the cutout making it possible to improve the working conditions of the operators considerably.

The invention has a particularly important, although not exclusive, application in the field of forming boxes from cutouts or panels of corrugated board with a low grammage (<120 g/m²) for the food industry, said cutouts having a tendency to stick to one another and thereby prevent gripping of the cutouts at a high rate without error.

With the invention, it will be possible to carry out the unstacking of the cutouts automatically without having to extract them from their last handling palette, on condition of prior visual checking by an operator of the correctly vertically stacked state of the cutouts.

“Correctly vertically stacked” is intended to mean stacked with a position intolerance of ±1 cm in the lateral offset of the cutouts, which is the general case with cutouts of a palette hooped in the usual way for its transport. By subsequently providing a system for unitary taking of each cutout from such a pallet of correctly stacked cutouts, it furthermore allows optional geometrical shaping after applying adhesive to said cutout, using the same tool, writing a barcode by inking and/or fixing an RFID chip or any other identification means, which may also be carried at the same time and in continuity of movement.

It also makes it possible to access all the cutouts of the pallets without losing the last cutouts.

In order to do this, the invention is based in particular on the idea of no longer moving the packs of panels piecewise to a generally inclined supply magazine, but to leave them on their handling palette, or, which amounts to the same thing, to push them simply in a block from their palette to a magazine with vertical movement, then to process the cutouts one by one after having advanced them vertically, for example by means of an elevator plate, to a plane for taking the cutout, where they are aligned, framed and held one by one in the gripping position.

The unstacking from above makes it possible to align and regulate the mechanism by using servomotors, for example, eliminating the transfer channel, as well as the mobile frame of the so-called klik/klok magazines of the prior art.

To this end, the invention provides in particular a device for forming a packaging box from at least one magazine for storing a stack of corrugated board cutouts, comprising means for advancing the stack as it is unstacked and means for unstacking the cutouts by suction, characterized in that, the stask of cutouts being vertical, the means for advancing the stack comprise a plate for elevating the stack vertically to a plane for taking the top cutout, and in that the device comprises means for referencing in X, Y, Z the position (pᵢ) of the top cutout in the magazine and means for calculating the trajectory in x, y, z, comprising a vertical component, means for unstacking as a function of said position (pᵢ), which are arranged in order to control the movement of said unstacking means between a position for taking the cutout and a position for positioning on a determined workstation, also referenced in X, Y, Z.

In advantageous embodiments, one and/or other of the following arrangements is furthermore implemented:

y is equal to 0, y means the horizontal component in the direction of the axis Oy of the reference frame X, Y, Z;

the stack of cutouts being vertical, the means for advancing the stack comprise a plate for elevating the stack vertically to a plane for taking the top cutout, and the device comprises pre-unstacking means arranged in order to separate the top cutout from the rest of the stack, and means for aligning said cutout in order to frame it and keep it separated from the rest of the stack in position for gripping by the unstacking means after removal of the pre-unstacking means;

the device comprises means for holding at the upper part of the stack when the bottom cutout of the stack has reached a determined level, and means for automatically placing a new stack below the remaining part of the previous stack, which is capable of ensuring continuity of the unstacking;

the means for holding at the upper part comprise free catches pivoting between a position for sliding along the edge of the stack of cutouts and a position for supporting the bottom of the stack under the effect of gravity;

the device comprises means (which are part of the referencing means) for telemetric measurement of the position (pᵢ) of the top cutout, and said means for calculating the trajectory in x, y, z of the unstacking means as a function of said position (pᵢ), arranged in order to control the movement of said unstacking means between a position for taking the cutout and a position for positioning on a determined workstation, and in order to calculate during the movement time the trajectory for the next cutout position (pᵢ₊₁), and so on;

the alignment means comprise a first set of grippers at a reference height X of the stack, and a second set of grippers at a height Y located at a height distance of between 1 and 20 mm from the reference X, and for separating the top cutout from the next cutout;

the comprises means for assisting the separation of the top cutout from the rest of the stack by blowing grazing air onto the top of the cutout;

the blown air is injected through nozzles which are inclined with respect to the surface of the top cutout at a pressure of between 1 and 2 bar relative;

the unstacking means comprise an on-board system provided with a robotized arm for moving said cutout to a next station, with a view to shaping it, before returning empty to take the next top cutout;

the device furthermore comprises means for applying adhesive to said cutout before the next station;

it comprises at least two magazines and/or stacks of cutouts, from which at least two top cutouts are taken in order to have adhesive applied to them and be placed on one another in order to form a box in at least two parts;

it comprises a plurality of robotized arms working in parallel.

the magazine cutouts comprises a pallet, the elevator plate being arranged in order to move said pallet, and the cutouts which it supports, vertically to an observation and removal plane, and in that the device comprises visual detection means;

the device comprises a station for shaping by folding the cutouts around a determined volume, for example a mandrel.

It also provides a method for producing packaging boxes of polygonal cross section from a device as described above.

The invention also provides a method for producing packaging boxes of polygonal cross section from a magazine formed by at least one vertical stack of cutouts of corrugated sheet board material or corrugated board, characterized in that,

the stack being vertical, the top cutout of the stack is brought to a determined height by means of a vertical elevator,

said cutout is separated from the rest of the stack by pre-unstacking means,

said cutout is aligned in order to frame it and keep it separated from the rest of the stack in the gripping position,

the pre-unstacking means are removed,

said cutout is gripped by suction with the aid of unstacking means,

said cutout is moved with the aid of said unstacking means comprising a robotized arm,

it is released at a subsequent station, for example with a view to shaping it, and

the cycle of steps above is repeated with the next top cutout.

Advantageously, the stack is held in the upper part when the bottom cutout of the stack has reached a determined level, the vertical elevator is lowered, a new stack is automatically placed on said elevator below the remaining part of the previous stack, and the vertical elevator is raised again so that the bottom cutout of the stack in the upper part rests on the top cutout of the new stack, in order to ensure continuity of the unstacking.

Also advantageously, the invention provides a method in which a plurality of robotized arms working in parallel are used, and/or the position (pᵢ) of the top cutout is measured by telemetry by calculating the trajectory of the unstacking means as a function of this position and by controlling the unstacking means between the position for taking the cutout and the position for positioning on a determined workstation, for example a mandrel, and by calculating during the masked time of the movements the trajectory for the next cutout position (pᵢ₊₁), and the operation is repeated for each of the following cutouts.

Advantageously the cutout is aligned with the aid of a first set of grippers at a reference height X of the stack, and the top cutout is separated from the next cutout by a second set of grippers at a height Y located at a height distance of between 1 and 20 mm from the reference X.

Advantageously the separation of the top cutout is assisted by blowing grazing air onto the top of the cutout.

The invention will be understood more clearly on reading the following description of embodiments, which are given below by way of nonlimiting example.

It refers to the accompanying drawings, in which

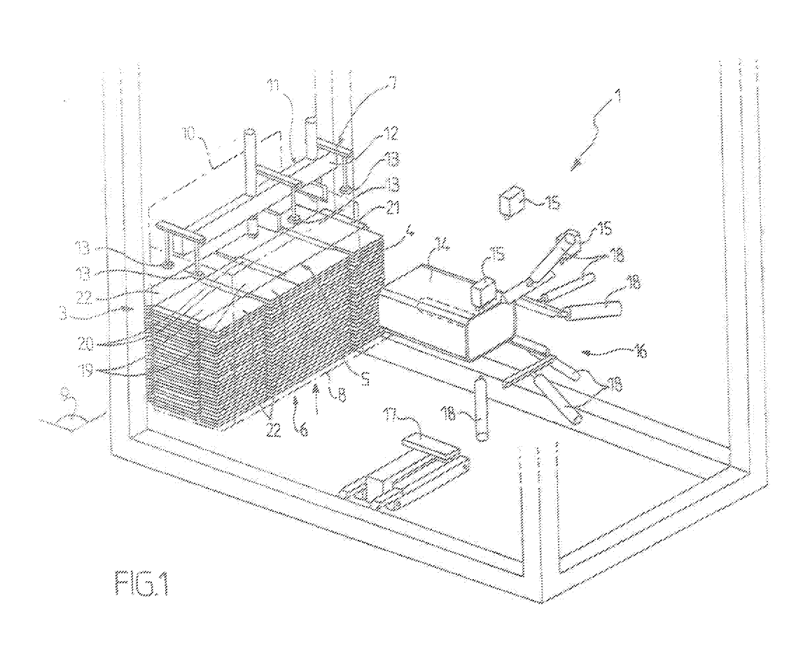

FIG. 1 is a partial schematic view in exploded perspective of a first embodiment of a device according to the invention.

FIGS. 1A, 1B and 1C illustrate the subsequent steps of forming a box with a part of the device in FIG. 1.

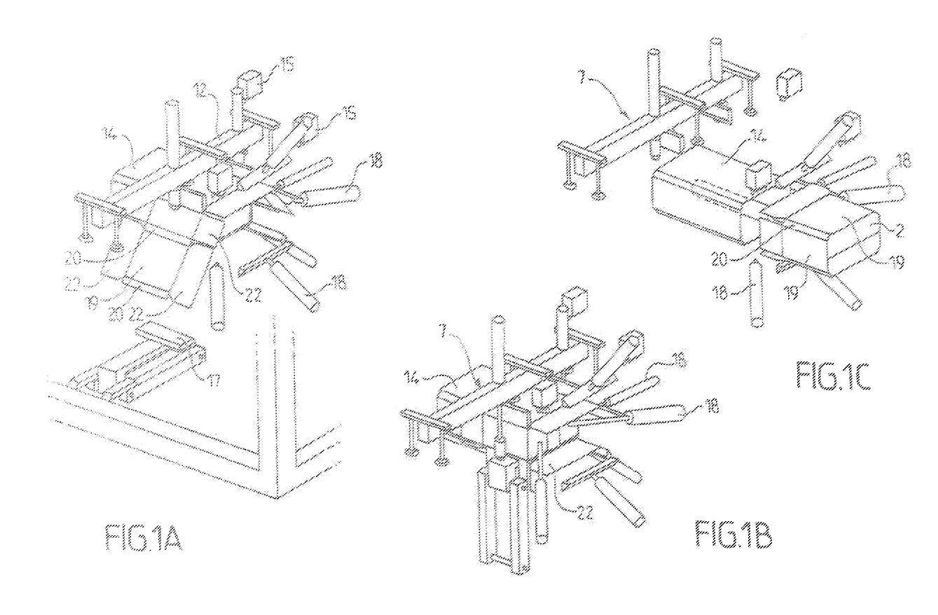

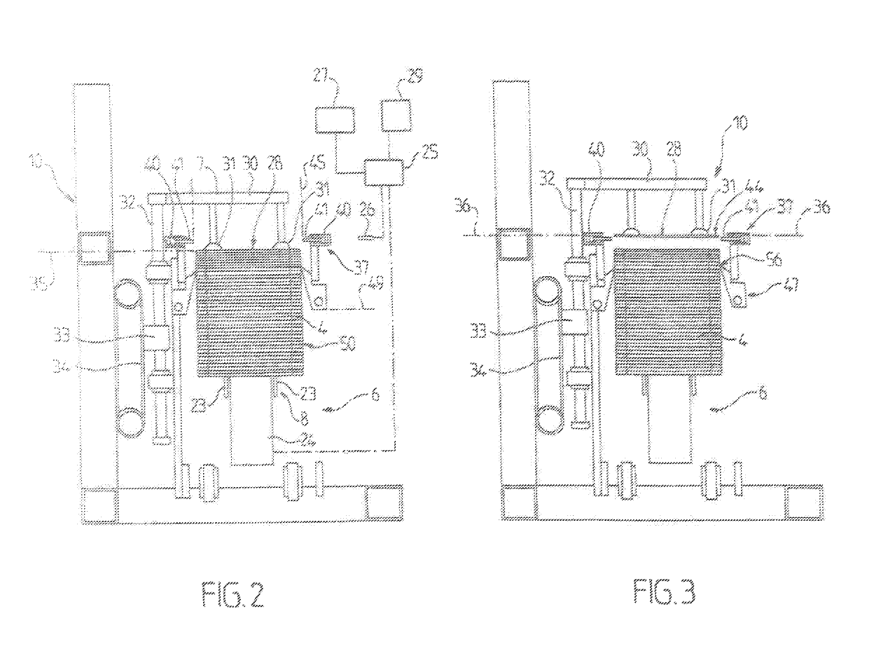

FIGS. 2 to 6 show side views of he advancing means, the pre-unstacking means and the means for unstacking a stack, according to the embodiment of the invention more particularly described here.

FIGS. 7A and 7B are schematic views in section illustrating another embodiment of the alignment means if according to the invention.

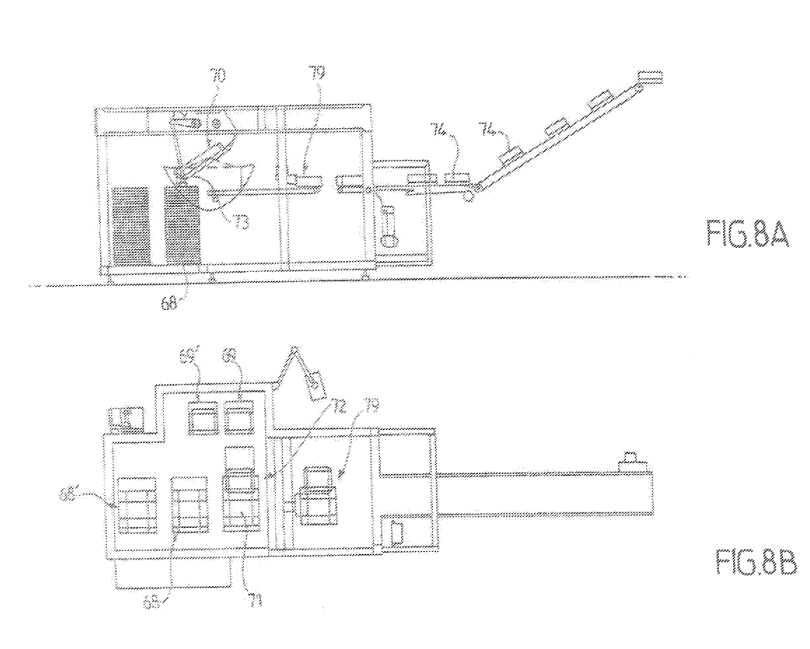

FIGS. 8A and 8B schematically show a side view and a view from above of another embodiment of a device according to the invention, with two stacks of cutouts.

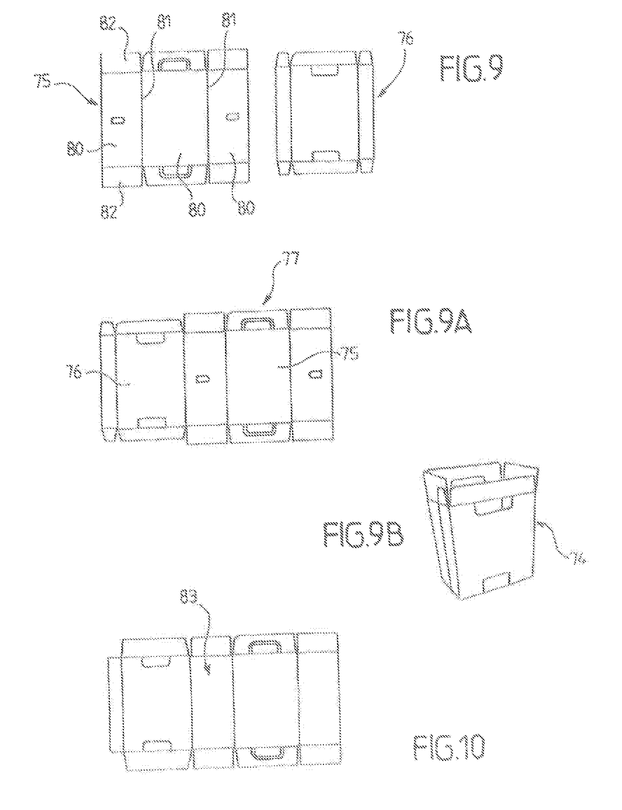

FIGS. 9, 9A and 9B successively illustrate a set of cutouts which are separated, have adhesive applied to them then are shaped into a box with the aid of a machine according to one embodiment of the invention.

FIG. 10 is a plan view of another embodiment of a cutout which can be used with the invention.

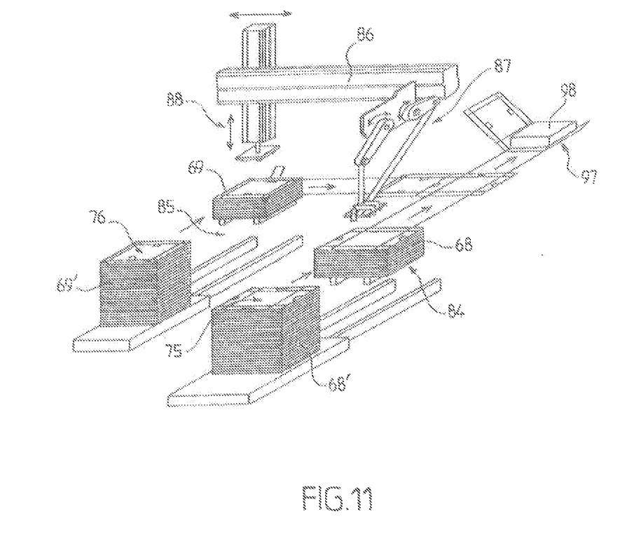

FIGS. 11 to 13 partially and schematically show, in axonometric perspective, the main steps of implementing the device of FIGS. 8A and 8B starting with cutouts described with reference to FIGS. 9, 9A, in order to form the box in FIG. 9B.

FIGS. 1, 1A, 1B and 1C schematically show, fully or partially, a device 1 for forming a box 2 from at least one magazine 3 with a constant level for storing a stack 4 of corrugated board cutouts 5, comprising means 6 for advancing the stack as it is being unstacked, and means 7 for unstacking the cutouts by suction.

The stack 4 of cutouts being vertical, the means of advance comprise a plate 8 (shown by dots and dashes) for elevating the stack vertically to a plane 9 for taking the top cutout.

The device 1 comprises pre-unstacking means 10, here again symbolized by dots and dashes in FIG. 1, which will be detailed more particularly with reference to FIGS. 2 to 6.

The unstacking means 7 comprise a system 11 formed by a partly horizontal arm 12 provided, for example, with three parallel branches for supplying compressed air and for positioning six suckers 13 (two per branch) for gripping by suction, which are known per se.

The arm can be moved horizontally, for example by means of a chain and/or electric motors (not represented), between the position for gripping the cutouts above the magazine and the next step, for example folding around a mandrel 14, after application by guns 15 of liquid adhesive under pressure, of the type known by the term “hot melt”, the box being formed by compression on the mandrel by presser means 16 (lower pusher plate 17 capable of being deployed vertically, lateral pusher cylinders 18, etc.).

In the example more particularly described here, the cutout 5 comprises eight flaps, namely four main flaps 19 separated by small intermediate flaps 20 forming cut corners and terminated by a tongue 21 for adhesive bonding onto the end intermediate flap.

The flaps are provided on either side, in a known manner, with tabs 22 intended to form the bottom and top of the box 2.

In the rest of the description, the same reference numbers will be used to denote the same elements or similar elements.

FIGS. 2 to 6 more precisely show in side view the means 6 for advancing the stack 4, and the pre-unstacking means 10, according to the embodiment of the invention mere particularly described here.

The means 6 for advancing the stack comprise an elevator plate 8, for example formed by two angle pieces 23 for horizontal support of the last cutout of the bottom of the stack 4 and a vertically pushing cylinder 24, controlled by an automaton 25 ensuring programmed raising of the plate as the cutouts are removed, which is controlled. by optical measuring means 26.

More precisely, these optical means are associated, by means known per se, with means 27 of the laser reader type for telemetric measurement of the position p(i) of the top cutout 28 and means 29 (microprocessor) for calculating the trajectory of the unstacking means 7 as a function of said position (pᵢ), arranged in order to control the movement of the unstacking means between a position (plane 9) for gripping the cutout and a position for positioning on a determined workstation, and in order to calculate during the movement time (in masked time), the trajectory for the next cutout position (pi+1), and so on.

The time diagram followed is, for example, of the following types:

initialization with selection of the offset values according to a format stored in a database,

movement of the robotized arm to the reference of the magazine and as a function of the offsets of the format,

reading by telemetry of the initial position if need be and/or calculation of the initial position,

calculation of the forward. trajectory,

realignment with the reference of the magazine of cutouts,

once the position, has been reached, calculation then lowering onto the cutout according to predetermined values or according to values which are measured by using telemetry,

evacuation of the suckers in order to suction the cutout,

execution of the trajectory then, if necessary, reading the telemetry height,

calculation of the return trajectory or otherwise taking the parameters of the trajectory from the database,

turning off the vacuum in order to release the cutout at the appropriate position,

execution of the return trajectory, and

restarting the cycle.

The pre-unstacking means 10 comprise a horizontal robotized arm 30 provided with at least four suckers 31 for gripping the cutout 28, the arm being fixed to vertical rod 32 which is off-center with respect to the stack and arranged at the side of the latter.

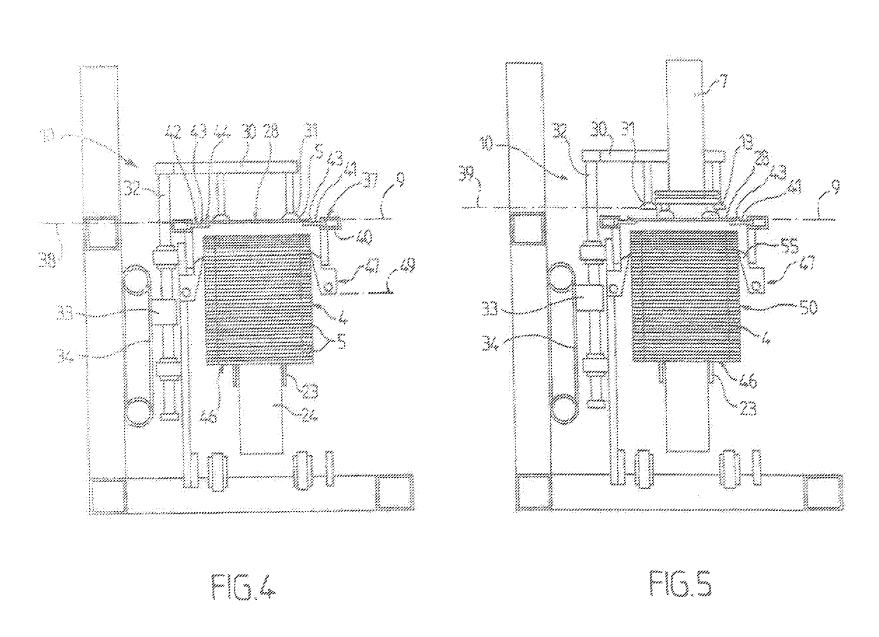

Said rod 32 is guided and fixed by a sleeve 33 to a chain 34 for actuation between a gripping position 35 (in dots and dashes in FIG. 2), a position 36 (FIG. 2) for withdrawal of the cutout above the alignment means 37, a position 38 (FIG. 4) for depositing the cutout on said alignment means 37 for gripping in the plane 9 and a position 39 (FIG. 5) for withdrawal heightwise and laterally, allowing the unstacking means 7 to take the aligned cutout 28.

More precisely, the alignment means 37 comprise, on either side of the volume occupied by the stack 4 of vertically mobile cutouts, two chutes 40, for example formed by two tubes having a C-shaped cross section, of which the opening of the branches lies on the side of the stack and in which at least two sliding catches 41 are respectively mounted movably in translation parallel to the branches of the C, these catches being formed by metal tongues provided in the upper part 42 with a lug 43 for wedging the periphery 44 of the blank 28, in order to frame it precisely and hold it on said catches in abutment positioning once they have moved from their release position (in dots and dashes 45).

The catches 41 are, for example, activated by a system of small cylinders with return springs (not represented) for returning to the nominal release position at rest.

They are controlled by the automaton 25 in order to move said catches between their abutment position and their release position.

During the operation of the pre-unstacking and unstacking means, the stack of cutouts is emptied and the plate formed by the angle pieces 23, which support the last cutout 46, rises. There comes a time when it is in a position such that the means 47 for holding in the upper part of the stack can be automatically triggered.

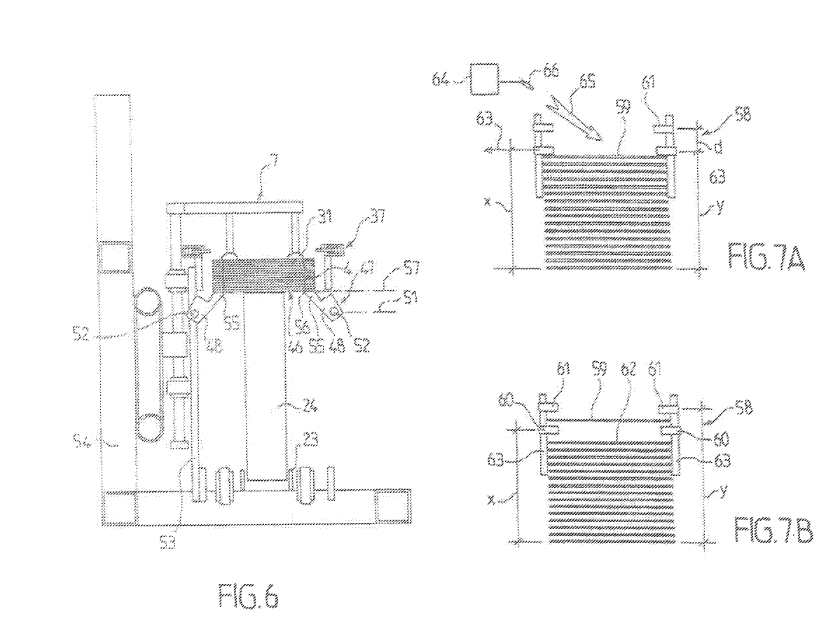

These means consist, for example, of free catches 48 pivoting between a position 49 (cf. FIGS. 2 to 5) for sliding along the edge 50 of the stack of cutouts and a position 51 (cf. FIG. 6) for supporting the bottom of the stack under the effect of gravity.

More precisely, the holding means 47 comprise catches 48 formed by a piece which is free and/or foolish in rotation with respect to an axle 52 secured to a rod 53, the fixed height of which can be adjusted, to the chassis 54 of the device.

The catches have an end lug 55 arranged to slide along the edge of the stack.

The lug 55 has, for example, a substantially triangular cross section forming a tip 56 for contact with the edge of the stack.

When the tip of the lug 55 is no longer in contact with the edge of the stack, because it is too high, said edge is no longer retained and the catch pivots about its axle 52 under the effect of gravity.

It is then arranged in order to be placed in a horizontal abutment position 57, on which the last cutout 46 can rest, releasing the plate formed by the angle pieces 23.

It is then possible to relower it by actuating the pusher cylinder vertically as far as its initial low position. A new stack of cutouts may then be placed on said plate, for example by pushing it from a pallet.

It is then sufficient to raise the stack until it comes in contact with the lugs 55, which will then pivot until the last cutout of the rest of the stack above comes in contact with the first cutout of the stack below.

A stack is thus fully reconstituted without a break in loading for manufacturing boxes according to the invention.

FIGS. 7A and 7B represent another embodiment of the means 58 for aligning the top cutout 59.

They comprise a first set of grippers 60 at a reference height X of the stack, and a second set of grippers 61 at a height Y located at a height distance d of between 1 and 20 mm from the reference X, and for separating the top cutout 59 from the next cutout 62.

This set of grippers operates in the following way.

When the top cutout 59 of the stack comes in contact with the first set of grippers, the latter retract outward (arrow 63). The cutout can then rise by being pushed by the cylinder 24 and then be positioned between the two sets of grippers. The first set of grippers 60 is then returned into place, as shown in FIG. 7B, this set being dimensioned and sized in order to be inserted, automatically between the two successive cutouts.

The top cutout 59 is thus isolated while being aligned between two rods 63 for control/reframing of the cutouts, also adjustable In translation with respect to the stack.

According to one embodiment of the invention, the device also comprises means 64 for assisting the separation of the top cutout by blowing grazing air 65 onto the Lop of the cutout.

Here, the blown air is injected through nozzles 66 which are inclined with respect to the surface of the top cutout at a pressure of between 1 and 2 bar relative.

FIGS. 8A and 8B schematically represent in side view and in view from above an embodiment of a device 67 according to invention, here comprising two vertical stacks 68, 69 of cutouts (with the stacks 68′, on standby to avoid breaks in the loading), a robotized arm 70 for moving a first cutout 71 coming from the stack 68 to a next station 72 for assembly, for example formed by a system 73 for gripping by suckers, then tilting, as will be detailed below with reference to FIGS. 11 to 13.

For its part, the other stack 69 of cutouts is emptied by means of another robotized arm (not represented), which will make it possible to form the two-part packaging 74 in FIG. 9B, therefore obtained from cutouts 75 and 76 (cf. FIGS. 9 and 9A,) in order to adhesively bond the first cutout 75 on the second cutout 76 in order to form the assembly 77, and mounting around a mandrel 78.

Here, there are therefore two robotized arms working in parallel, which will make it possible to obtain the box 74 after wrapping around a mandrel.

In this embodiment, the cutout 75 is formed by three rectangular flaps 80 connected together by parallel folding lines 81 and provided on either side with rectangular tabs 82, in a manner known per se, in order to form the lid and the bottom of the packaging.

For its part, the cutout 76 is formed in a similar way but in order to constitute a lower tray.

It is also possible to only use a single cutout 83, as represented in FIG. 10. In this case, a single stack of cutouts is employed.

FIGS. 11, 12 and 13 represent in more detail the system for forming the box with the two cutouts 75, 76 from the two stacks 68, 69 supplied by the two parallel vertical magazines 84, 85 with a constant level, of the type described above for example with reference to FIGS. 2 to 6.

The implementation of the method and the device according to the invention will now be described with reference being made particularly to FIGS. 2 to 6 and 11 to 13.

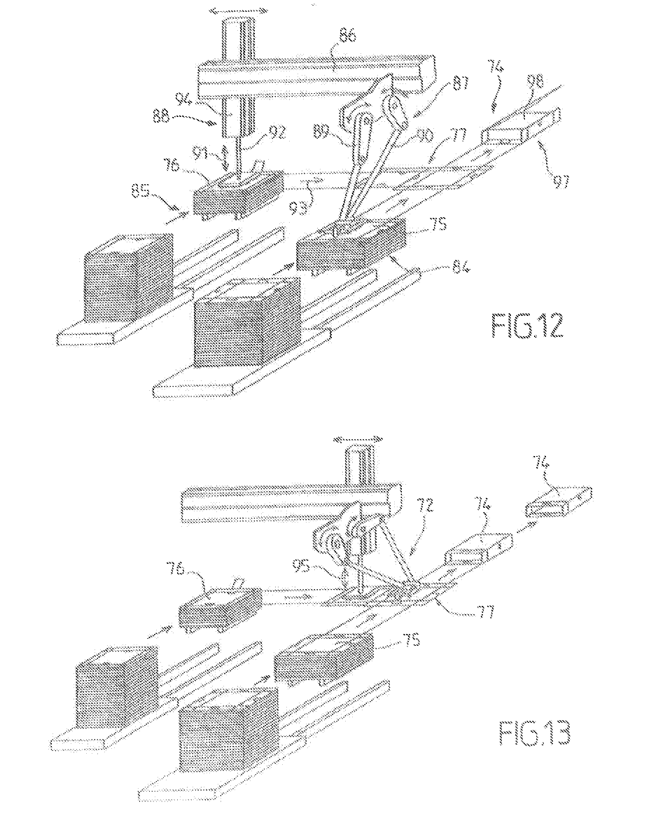

Starting with the two magazines 84 and 85 respectively comprising the vertical stacks 68 and 69 of cutouts, the top cutout 38 of each magazine is brought to a determined height (FIG. 2, FIG. 11), said cutouts are aligned in order to frame them and in order to keep them separated from the rest of the stack by the pre-unstacking means (FIG. 4), then, after withdrawal of the pre-unstacking means, the cutouts are gripped (FIG. 5, FIG. 12) by suction with the aid of the unstacking means, which are themselves secured to a fixed part 86 by means of two systems 87 and 88, which make it possible to move the cutouts gripped in this way to the assembly station 72.

More precisely, the system 37 comprises two articulated arms 89 and 90 making it possible to bring the cutout in a single movement, after it has been separated, to its assembly station, while simultaneously the system 88 raises (arrow 91) the cutout of the stack 69 using a vertical jack 92 then deposits it horizontally (arrow 93) by a mobile carriage 94 along the beam 86 at its depositing station before lowering into position (arrow 95) on the cutout in order to form the assembly 77 after application of adhesive (not represented) on their respective path in a manner known per se.

The assembly 77 is then transferred (arrow 96) to the station 97 for assembly, for example around a mandrel 98.

As presented in the figures, and when the lower cutout of stacks exceeds a certain level, the automaton detects the tilting of the catches in a manner known per se.

Without stopping the device, which continues to empty the stacks above said catches, the carriage 24 is lowered again, and is put in position to receive the stack (68′, 69′) on standby.

This stack is then pushed (arrows 99) in a known manner and automatically in order to position it under the rest of the previous stack.

The new stack is then raised in order to integrate it with the rest of the previous stack, thereby avoiding any break in continuity in the formation of the boxes.

As is evident, and as moreover emerges from the description above, the present invention is not limited to the embodiments more particularly describe. Rather, it encompasses all variants thereof, and particularly those in which the cutouts are of different shapes.

1. A device (1) for forming a packaging box (2, 74) from at least one magazine (3) for storing a stack (4, 68, 69) of corrugated board cutouts, comprising means (6) for advancing the stack as it is unstacked and means (7) for unstacking the cutouts by suction, characterized in that, the stack of cutouts being vertical, the means (6) for advancing the stack comprise a plate (8) for elevating the stack vertically to a plane (9) for taking the top cutout (28),
and in that the device comprises means (27) for referencing in X, Y, Z the position (pᵢ) of the top cutout (28) in the magazine and means (29) for calculating the trajectory in x, y, z, comprising a vertical component, means for unstacking as a function of said position (pᵢ), which are arranged in order to control the movement of said unstacking means between a position (9) for taking the cutout and a position for positioning on a determined workstation, also referenced in X, Y, Z.

2. The device as claimed in claim 1, characterized in that y is equal to 0.

3. The device as claimed in claim 2, characterized in that the device comprises pre-unstacking means (10) arranged in order to separate the top cutout from the rest of the stack, and means (37, 58) for aligning said cutout in order to frame it and keep it separated from the rest of the stack in position for gripping by the unstacking means after removal of the pre-unstacking means.

4. The device as claimed in claim 3, characterized in that it comprises means (47) for holding at the upper part of the stack when the bottom cutout of the stack has reached a determined level, and means for automatically placing a new stack below the remaining part of the previous stack, which is capable of ensuring continuity of the unstacking.

5. The device as claimed in claim 4, characterized in that the means (47) for holding at the upper part comprise free catches (48) pivoting between a position for sliding along the edge (50) of the stack of cutouts and a position (51) for supporting the bottom of the stack under the effect of gravity.

6. The device as claimed in claim 1, characterized in that said referencing means comprise means (27) for telemetric measurement of the position (pᵢ) of the top cutout (28), and in that the means (29) for calculating the trajectory of the unstacking means as a function of said position (pᵢ), arranged in order to control the movement of said unstacking means between a position (9) for taking the cutout and a position for positioning on a determined workstation, are arranged in order to calculate during the movement time the trajectory for the next cutout position (pᵢ₊₁), and so on.

7. The device as claimed in claim 1, characterized in that the alignment means (58) comprise a first set of grippers (60) at a reference height X of the stack, and a second set of grippers (61) at a height Y located at a height distance of between 1 and 20 mm from the reference X, and for separating the top cutout from the next cutout.

8. The device as claimed in claim 1, characterized in that it comprises means (64) for assisting the separation of the top cutout from the rest of the stack by blowing grazing air onto the top of the cutout.

9. The device as claimed in claim 8, characterized in that the blown air is injected through nozzles (66) which are inclined with respect to the surface of the top cutout at a pressure of between 1 and 2 bar relative.

10. The device for forming a box as claimed in claim 1, characterized in that the unstacking means (7) comprise an on-board system provided with a robotized arm (70, 87, 88) for moving said cutout to a next station, with a view to shaping it, before returning empty to take the next top cutout.

11. The device as claimed in claim 10, characterized in that it furthermore comprises means (15, 16) for applying adhesive to said cutout before the next station.

12. The device as claimed in claim 1, characterized in that it comprises at least two magazines and/or stacks (68, 69) of cutouts, from which at least two top cutouts (70, 71) are taken in order to have adhesive applied to them and be placed on one another in order to form a box in at least two parts.

13. The device as claimed in claim 1, characterized in that it comprises a plurality of robotized arms (87, 88) working in parallel.

14. The device as claimed in claim 1, characterized in that the magazine of cutouts comprises a pallet, the elevator plate being arranged in order to move said pallet, and the cutouts which it supports, vertically to an observation and removal plane, and in that it comprises visual detection means.

15. The device as claimed in claim 1, characterized in that it comprises a station (97) for shaping by folding the cutouts around a determined volume.

16. A method for producing packaging boxes of polygonal cross section from a magazine formed by at least one vertical stack of cutouts of corrugated sheet board material or corrugated board, characterized in that the position (pᵢ) of the top cutout is measured by telemetry, the trajectory of the unstacking means is calculated as a function of said position (pᵢ), and the movement of said unstacking means, between a position for taking the cutout and a position for positioning on a determined workstation, is controlled by calculating during the movement time the trajectory for the next cutout position (pᵢ₊₁), and so on.

17. The method as claimed in claim 16, characterized in that
the stack being vertical, the top cutout of the stack is brought to a determined height,
said cutout is separated from the rest of the stack by pre-unstacking means,
said cutout is aligned in order to frame it and keep it separated from the rest of the stack in the gripping position,
the pre-unstacking means are removed,
said cutout is gripped by suction with the aid of unstacking means,
said cutout is moved with the aid of said unstacking means comprising a robotized arm,
it is released at a subsequent station, and
the cycle of steps above is repeated with the next top cutout.

18. The method as claimed in claim 17, characterized in that the stack is held in the upper part when the bottom cutout of the stack has reached a determined level, the vertical elevator is lowered, a new stack is automatically placed below the remaining part of the previous stack, and the vertical elevator is raised again so that the bottom cutout of the stack in the upper part rests on the top cutout of the new stack, in order to ensure continuity of the unstacking.

19. The method as claimed in claim 16, characterized in that it comprises more than thirty cycles per minute.

20. The method as claimed in claim 16, characterized in that a plurality of robotized arms working in parallel are used.

21. The method as claimed in claim 16, characterized in that the cutout is aligned with the aid of a first set of grippers at a reference height X of the stack, and the top cutout is separated from the next cutout by a second set of grippers at a height Y located at a height distance of between 1 and 20 mm from the reference X.

22. The method as claimed in claim 16, characterized in that the separation of the top cutout from the rest of the stack is assisted by blowing grazing air onto the top of the cutout.

23. The method as claimed in claim 16, characterized in that the box is shaped at a shaping station by folding the cutouts around a determined volume.
